(19) United States
(12) Patent Application Publication
(10) Pub. No.: US 2004/0068543 A1
(43) Pub. Date: Apr. 8, 2004

(54) Method and apparatus for processing e-mail

(76) Inventor: Ralph Seifert, West Palm Springs, FL (US)

Correspondence Address: BIRCH STEWART KOLASCH & BIRCH, PO BOX 747, FALLS CHURCH, VA, 22040-0747, US

(21) Appl. No.: 10/290,708

(22) Filed: Nov. 8, 2002

Related U.S. Application Data
(60) Provisional application No. 60/415,873, filed on Oct. 3, 2002.

(51) Int. Cl. G06F 15/16

(52) U.S. Cl. 709/206

(57) ABSTRACT

This invention relates to a method and system for allowing electronic mail (“e-mail”) users to control the acceptance and transmission of electronically mailed messages over a communications network such as the Internet by permitting the intended recipient (and/or at system administrator) to define what is authorized (i.e., acceptable). An e-mail processor constructed in accordance with the invention substantially eliminates communication of unauthorized e-mail to an intended recipient by permitting a definition of the characteristics of authorized e-mail. E-mail failing to include one or more such characteristic is rejected. Accordingly, the process includes means for reading selected data strings of e-mail, means for comparing the stored and read data strings to identify a match, and means for rejecting the e-mail if no match is found. The characteristics may, for example, be the sender's e-mail address, the sender's domain name, certain words or phrases in the “Subject” field of the e-mail, etc.

### FIELD OF THE INVENTION

This invention relates to a method and system for allowing electronic mail (“e-mail”) users to control the acceptance and transmission of electronically mailed messages over the Internet and/or an intranet communications network.

### BACKGROUND OF THE INVENTION

Unwanted e-mail, particularly the unsolicited type generated by mass marketers that is derogatorily referred to as “spam”, has become an increasingly costly, time- and effort-consuming annoyance to recipients and Internet Service Providers (“ISPs”) alike. Recipients must involuntarily spend their time identifying and deleting these messages, while ISPs must cope with the quantity of bandwidth absorbed by these unwanted mailings of mass marketers.

Despite the public's frustration with the magnitude and personal irrelevance of these mailings, there has been no reason to believe that its growth will diminish in the future. First, the distribution of e-mail is extremely inexpensive, so mass marketers can bury countless numbers of recipients in unsolicited mailings for a very small cost per customer. Secondly, there appears to be little that governmental agencies can do, given Constitutional issues pertaining to “free speech” and interstate commerce regulation, as well as jurisdictional and enforcement issues.

Accordingly, the burden of filtering and processing the unwanted e-mail has fallen on the e-mail user and the organizational System Administrators and/or ISP operators. Spam filters have recently begun to appear in the marketplace, but the known products all address only one facet of the problem, and all have limitations, which greatly reduce their effectiveness. This invention provides a method and a system that can be employed by e-mail users, recipients, organizational System Administrators and/or ISP operators to virtually, if not wholly, eliminate the transmission and/or receipt of unwanted e-mail.

This specification will use a number of terms familiar to those skilled in the art. These terms are explained briefly and simplistically below by way of example, and these explanations are not intended to limit the scope of this invention or preclude other systems, configurations and/or structures from being included where those systems, configurations and structures would be understood to be equally applicable by those of ordinary skill in the art.

The Internet is a globally accessible communication network comprising tens of thousands of independent networks. An Internet service provider (or “ISP”) is typically an organization which provides Internet and intranet services for multiple Internet client accounts, and gives external and/or internal customers access to, and use of, Internet facilities and resources. An intranet is typically an internal personal or organizational network which does not, by itself, contain the facilities and resources needed to access the Internet. A “system administrator” is typically a person (or persons) who has primary responsibility for, and authority necessary to maintain, the operational integrity and security of one or more hardware/software systems.

An “e-mail server” is typically a software component which resides in a hardware system that is connected to the Internet and/or an intranet carrying e-mail traffic, and which receives and transmits e-mails on behalf of e-mail users. An “e-mail user” can be an individual who sends and/or receives e-mail; in an organizational environment, it is typically considered to be the organization itself. An “e-mail username” is typically a domain-unique, case-insensitive string of characters which allows the e-mail user to be an e-mail recipient in the user's domain. An “e-mail address” is typically the username separated from the domain name by the symbol, “@”. In an organizational environment, there are typically a number of usernames identifying respective persons and/or departments within the organization.

This specification will refer to certain components of an e-mail message called “fields”. The “To: field” is that portion of an e-mail whose function is to contain the e-mail address of one or more recipients as specified by the author of the e-mail. It may or may not actually display the characters, “To:”. Similarly, the “From: field” is that portion of an e-mail whose function is to contain the e-mail address of the e-mail's originator, and may or may not actually display the characters, “From:”. Likewise, the “Subject:” field is that portion of an e-mail whose function is to briefly summarize the information content of the e-mail, and may or may not contain the characters, “Subject:”. The “Message:” field is that portion of an e-mail whose function is to convey the primary information content of the e-mail, and may or may not contain the characters, “Message:”.

A “text string” is typically any number of contiguous characters of a code set. If there are no characters in the string, it is referred to an “empty string” or a “null string”.

There are typically two types of system environments: a “personal environment”, such as an e-mail user would have at home, and an “organizational environment”, such as one which would exist within a company (including an ISP). An “organizational mail server” typically provides Internet and intranet e-mail services for multiple intranet clients, and is typically centrally managed by one or more system administrators. An ISP (or Internet service provider) typically provides Internet and e-mail services for multiple Internet client accounts. An “Internet client account”, in turn, typically provides access to the ISP's-Internet and e-mail services for one or more users, and may be individually managed by an Internet Client Account Administrator. The term “system administrator” will be used herein to refer to System Administrators, Account Administrators and ISP operators as appropriate.

### SUMMARY OF THE INVENTION

An e-mail processor is disclosed herein for virtually eliminating unwanted e-mail received and/or transmitted by permitting an e-mail user (and/or system administrator) to define the acceptance criteria for acceptable incoming e-mail, and/or the transmission criteria for acceptable outgoing e-mail. The processor comprises means for storing one or more data groups, each group consisting of from none to a plurality of group data strings. The stored group data strings are used to define which incoming e-mails are to be accepted and/or which out-going e-mails are to be transmitted by the e-mail server and/or e-mail client operating on the e-mail user's behalf. For example, data strings of one group identify one or more remote e-mail users and/or remote domain names from which e-mail is always to be accepted. Data strings of another group identify one or more local domain e-mail users for whom e-mail is always to be accepted. Data strings of another group comprise one or more words or phrases identifying subject matter for which the user is interested in receiving e-mail.

As indicated above, as few as one group or as many as all groups may be utilized by the e-mail user and/or administrator as desired. An e-mail processor constructed in accordance with the invention can likewise provide the administrator in an organizational operating environment with additional controls to determine which incoming e-mails should reach the intended recipient, and which e-mail messages from within the organization are acceptable for transmission.

An e-mail processor constructed in accordance with the invention accordingly includes, for example, means for monitoring data strings from at least one of the “From:”, “To:”, “Subject:” and “Message:” fields of the e-mail under consideration, as well as means for comparing the monitored data strings with stored group data strings to determine if the e-mail meets the criteria defined by the stored group data strings. For operating environments that include an administrator, the e-mail processor can include means for monitoring data strings from at least one of the fields of e-mail to be transmitted from that system in order to determine whether the transmission is authorized.

The processor additionally includes means for accepting the received e-mail for review by the intended recipient if any of the criteria defined by the group data strings for accepting e-mail are met, and for rejecting the e-mail if none of the criteria are met. For operating environments having an administrator, the processor can include means for permitting the transmission of e-mail meeting the authorization criteria defined by the group data strings for authorizing the transmission of e-mail, and for rejecting the e-mail if none of those criteria are met.

In a personal operating environment, the criteria are preferably defined by the user, although the account administrator may be provided with supplemental or superceding control as to some or all of the criteria depending on the policy of the ISP. In an organizational environment, the criteria can be defined by the organization's mail server's system administrator.

A processor constructed in accordance with the invention may be resident in the user's communication device (e.g., personal computer), and/or in the organizational or ISP mail server host system. Moreover, the processor can be used in conjunction with communications over the Internet, and intranet or any other group-communicating network.

A preferred embodiment of the invention is described in the following Description of the Preferred Embodiment, of which the drawing forms a part.

### DESCRIPTON OF THE DRAWING

FIG. 1 is a block diagram illustration of the prior art operating environments of typical Internet users;

FIG. 2 is a block diagram illustration of a processing environment for a preferred e-mail processor constructed in accordance with the invention and used in an organizational mail server operating environment;

FIG. 3 is a block diagram illustration of a processing environment for a preferred e-mail processor constructed in accordance with the invention and used in an “Internet Client Account” operating environment;

FIG. 4 is a block diagram illustration of another processing environment configuration for a preferred e-mail processor constructed in accordance with the invention in an “Internet Client Account” operating environment;

FIG. 5 is an illustration diagrammatically showing a preferred generic information structure for use a preferred e-mail processor constructed in accordance with the invention;

FIGS. 6-12 are illustrations that diagrammatically show the ith row of a preferred information structure for the Private Table, Public Table, Wanted Table, New Table, SAName Table, SADomain Table and SA Wanted Table, respectively, which are used in a preferred e-mail processor constructed in accordance with the invention;

FIG. 13 is an illustration diagrammatically showing a preferred configuration for creating and maintaining e-mail control lists used by an e-mail processor constructed in accordance with the invention;

FIGS. 14-15 are illustrations diagrammatically showing alternative configurations for creating and maintaining e-mail control lists used by an e-mail processor constructed in accordance with the invention as part of an organization's e-mail communication system;

FIGS. 16-17 are illustrations diagrammatically showing preferred character processing used in accordance with the invention in connection with preferred data strings of the preferred e-mail processor;

FIG. 18 is a block diagram illustration showing the preferred manner of information processing used to accept or reject received e-mail in accordance with the invention;

FIGS. 19-20 are logic diagrams illustrating the preferred process for accepting or rejecting received e-mail in accordance with the invention;

FIG. 21 is a block diagram illustration showing the preferred manner of information processing used to accept or reject the transmission of e-mail in accordance with the invention; and

FIGS. 22-23 are logic diagrams illustrating the preferred process for accepting or rejecting the transmission of e-mail in accordance with the invention

### DETAILED DESCRIPTION OF THE PREFERRED EMBODIMENT

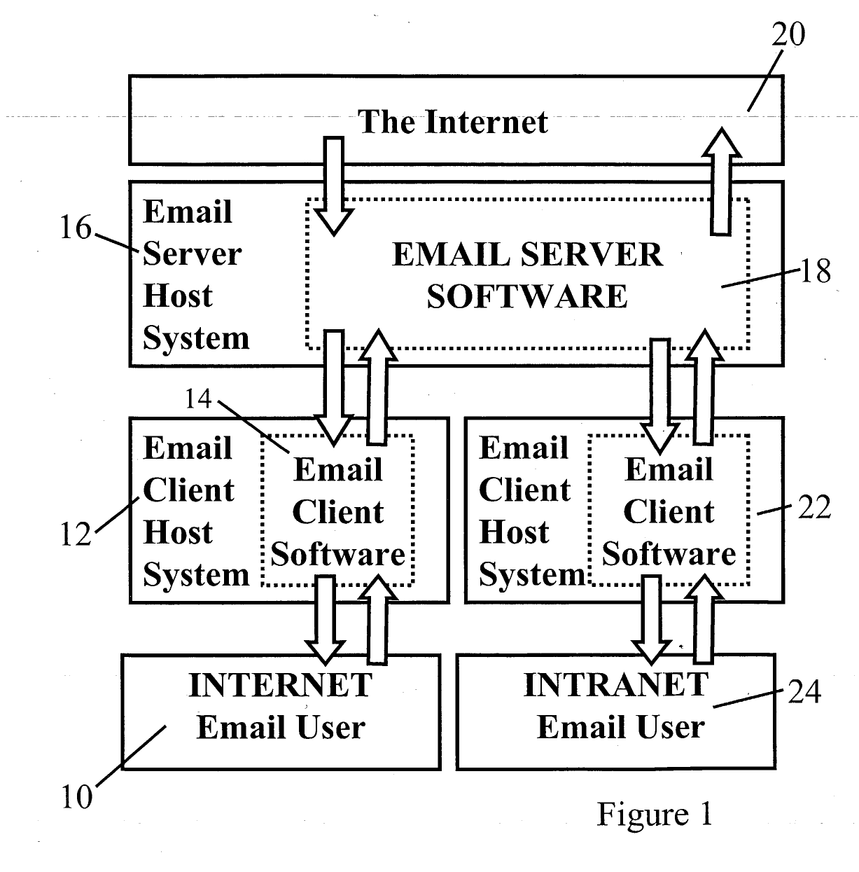

Referring initially to FIG. 1, the functional components of an Internet-based communication system is schematically illustrated as comprising a first e-mail user 10 in interactive communication with a first e-mail client host system 12 having first e-mail client software 14. The user is typically an individual who interactively communicates with the first host system by means of a keyboard, mouse, voice recognition software, etc. in order to generate commands necessary to interact with the communication system, while the host system typically communicates with the user by means of a video display and/or audio. Those skilled in the art will recognize that this invention is not limited to these methods for interactive communication between the user and host system, however, and that any other mediums or modes that are capable of presenting information to and from user are within the scope of this invention, as are users other than individuals.

The first e-mail client software 14 is typically a software package such as Microsoft's Outlook® or Outlook Express® or Netscape®. It may be physically resident on the user's host system, or may be accessed in real time from a remote storage location by the user's host system before or during use of the e-mail software by the user.

The client host system 12 is coupled for bilateral communication with an e-mail server host system 16 over a communication link such as telephone lines, satellite dish, and the like in the conventional manner. As will be appreciated, the specific type of link utilized is not important, and all are within the scope of the invention. The e-mail server host system 16 utilizes e-mail server software 18 to interface and communicate with other e-mail servers via the Internet 20.

In practice, the user 10 utilizes the host system 12 to upload (i.e. send) e-mail to, and download (i.e., receive) e-mail from the server 16 which, in turn, uploads and downloads the e-mail from other users via the Internet 20. Those other users may utilize other servers or, alternatively, utilize the same server as the user 10. This invention is not limited to either configuration.

For simplicity, FIG. 1 illustrates the use of the server host system 16 by only two users: an Internet user 10 and an Intranet user 24 with respective e-mail client host systems 12, 22. In practice, of course, there are many more users and client host systems utilizing each server, with the number of Internet and intranet users being limited only by the hardware and software capabilities of the particular server host systems. Those skilled in the art will recognize that other e-mail configurations exist, and that this invention is not limited to any particular configuration.

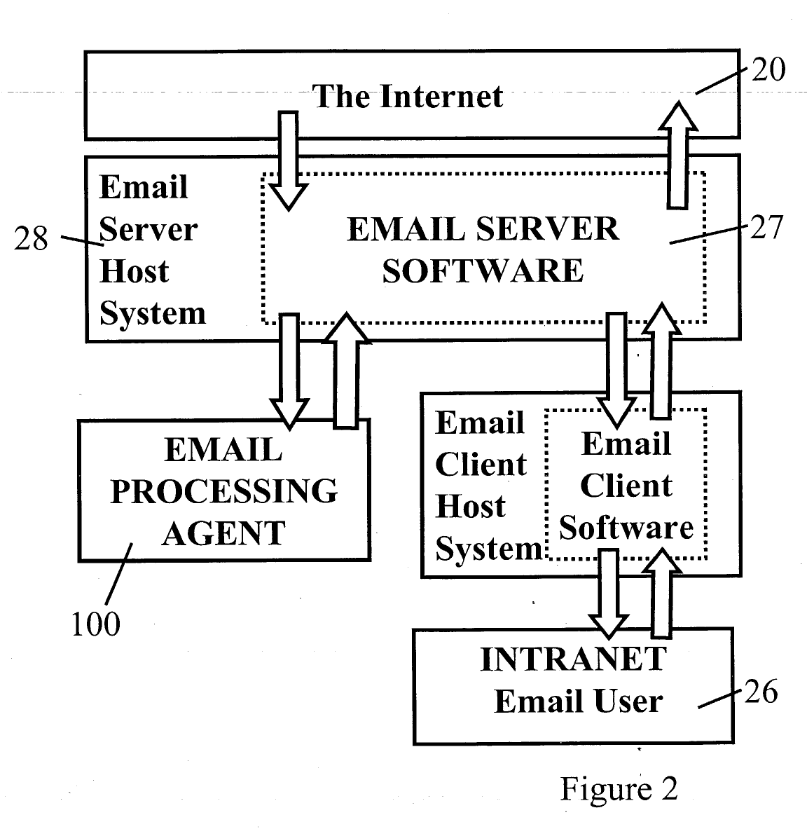

FIG. 2 is a schematic illustration of the e-mail processing environment utilized by a typical intranet e-mail user of an organizational mail server (such as that used by a corporation) that provides access to the Internet and an intranet to permit electronic communications among its employees as well as between at least some of its employees and the outside world. FIG. 2 is similar to the right side of FIG. 1 except for its illustration of a single representative intranet user 26 and the addition of an e-mail processor 100 in accordance with the invention to filter and virtually eliminate the receipt of unwanted e-mail in accordance with the invention. The e-mail processor 100 is illustrated in FIG. 2 as being installed for communication with the organization's server 28, which may be located within the organization's facility or, alternatively, at a remote site where it is coupled for communication with the organization's users via telephone lines, satellite links and/or other communication links.

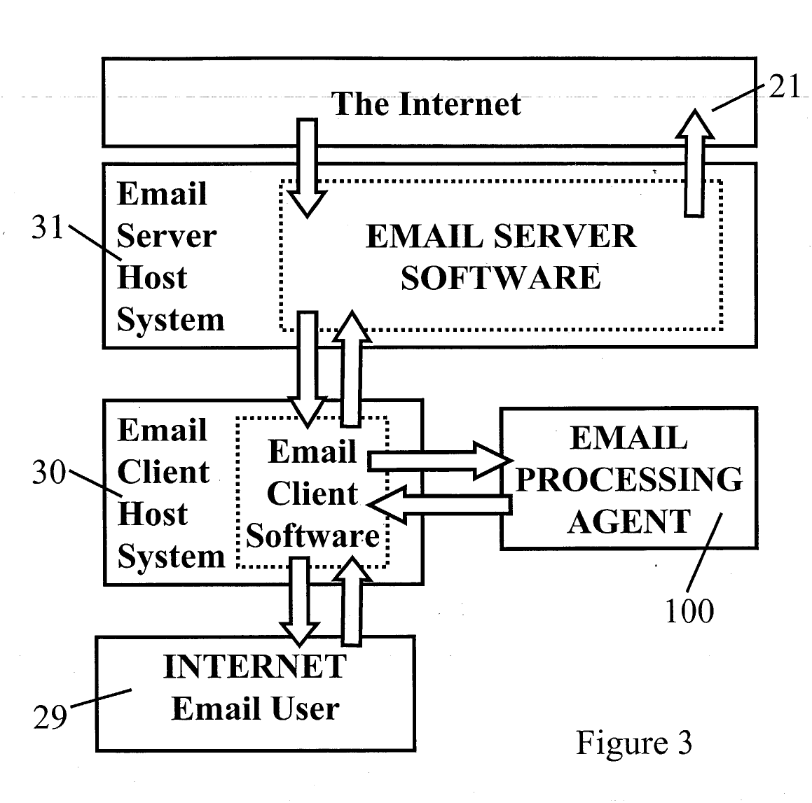

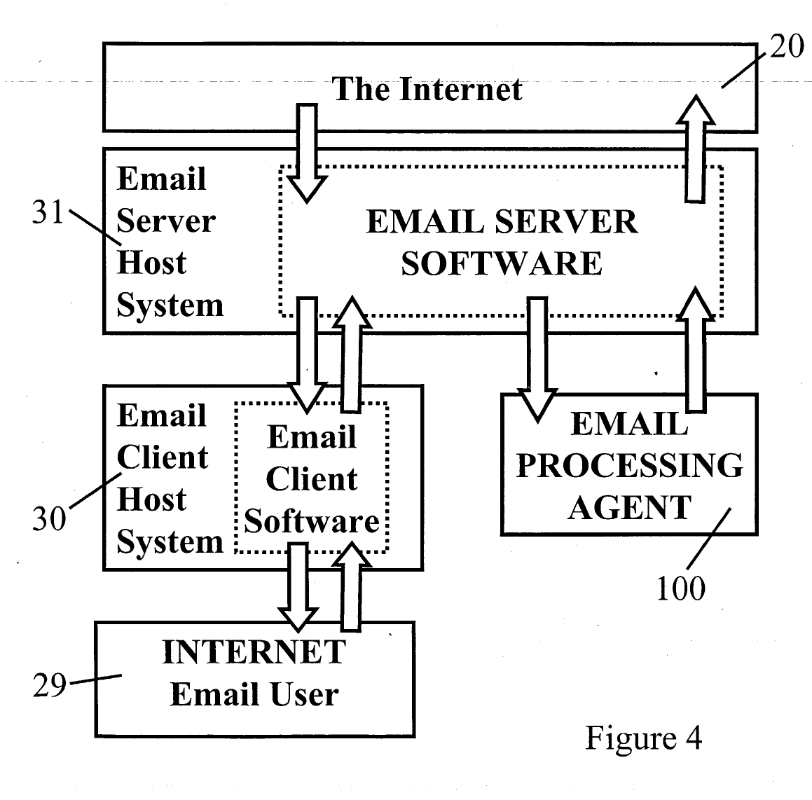

An alternative configuration for an e-mail processing environment is illustrated in FIG. 3, which schematically illustrates a typical e-mail processing environment utilized at home, for example, by a private individual 29. The illustrated configuration of FIG. 3 is similar to the left side of FIG. 1 except for the coupling of the e-mail processor 100 to the user's client host system 30. Alternatively, the e-mail processor 100 can be installed in the ISP's server 31 as illustrated in FIG. 4. Regardless of the particular configuration employed—be it that illustrated in FIGS. 2-4 or otherwise—the user receives essentially only that e-mail which that has been explicitly and specifically defined as e-mail the user wishes to receive, thereby essentially eliminating spam and other unwanted e-mail.

The e-mail processor 100 utilizes defined software algorithms implemented by the e-mail software manufacturer that interact with an e-mail server and/or e-mail client during e-mail reception and/or during e-mail transmission to (1) classify the reception as “acceptable” or “unacceptable”, and/or classify the transmission as “permitted or “not permitted”. An e-mail client in the Personal Environment (FIGS. 3-4) is capable of supporting multiple e-mail users in that environment by providing those security mechanisms such as passwording to allow one or more e-mail users in that environment to obtain exclusive rights to create and modify the rules for what e-mail is accepted and/or permitted. One personal environment e-mail user can be vested with some portion or all of the authority and control rights in the personal environment that are vested in the system administrator in the organizational environment.

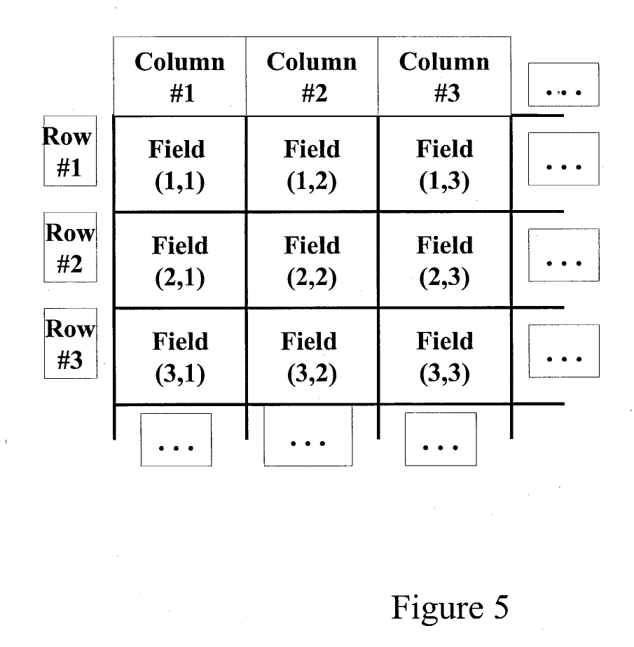

The preferred e-mail processor 100 includes means for structuring and storing one or more groups of data strings, with the preferred structure of each group generically illustrated in FIG. 5 as a matrix. Each data string comprises one or more data fields, with each field being conveniently identified herein by the row number and column number of the field's location within the matrix. Thus, the data string of row 1 comprises data field 1,1 (or, simply “field 1,1”) plus field 1,2 plus field 1,3 etc.

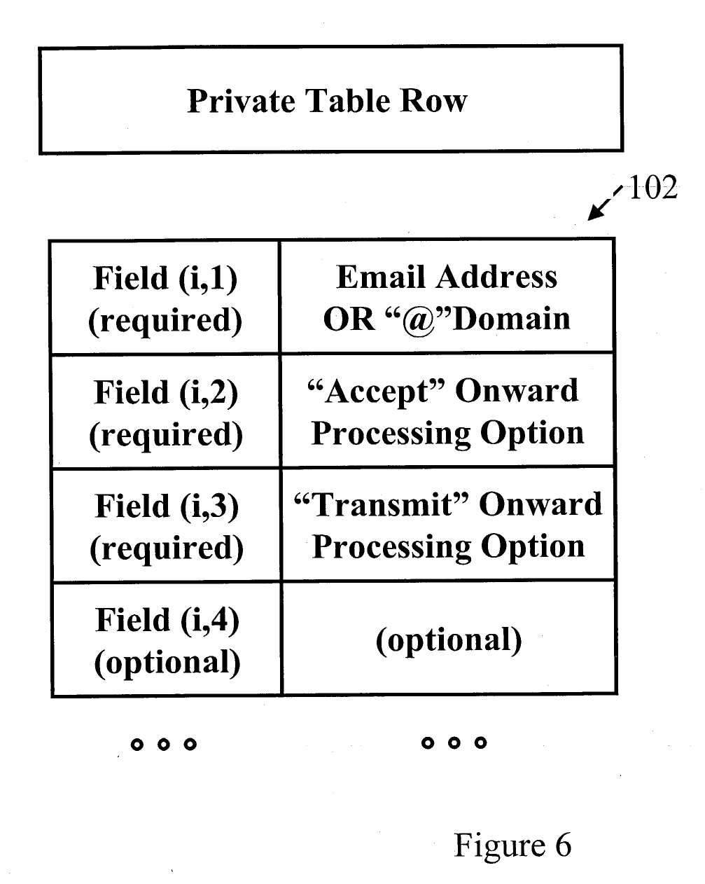

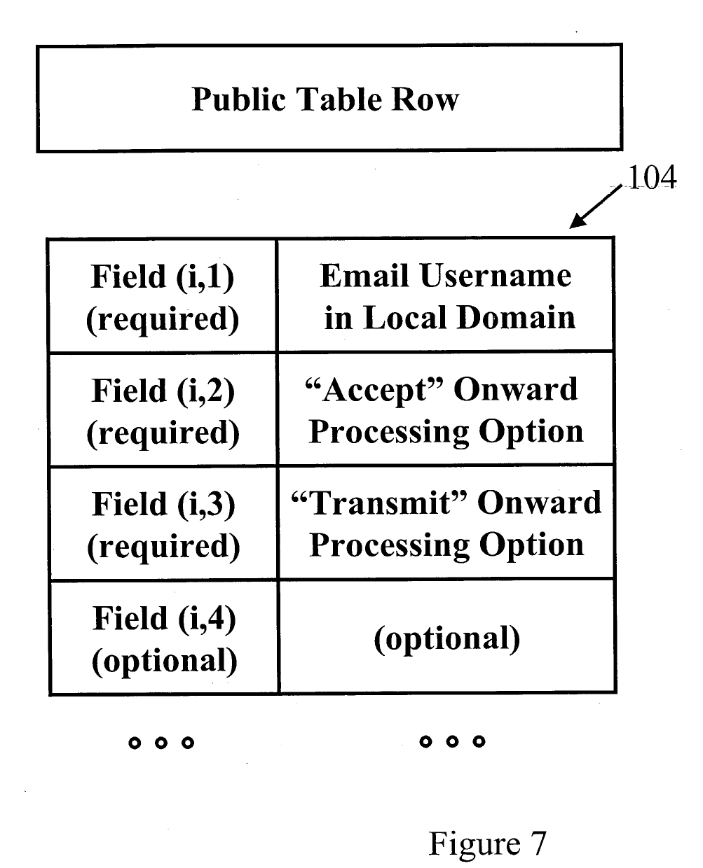

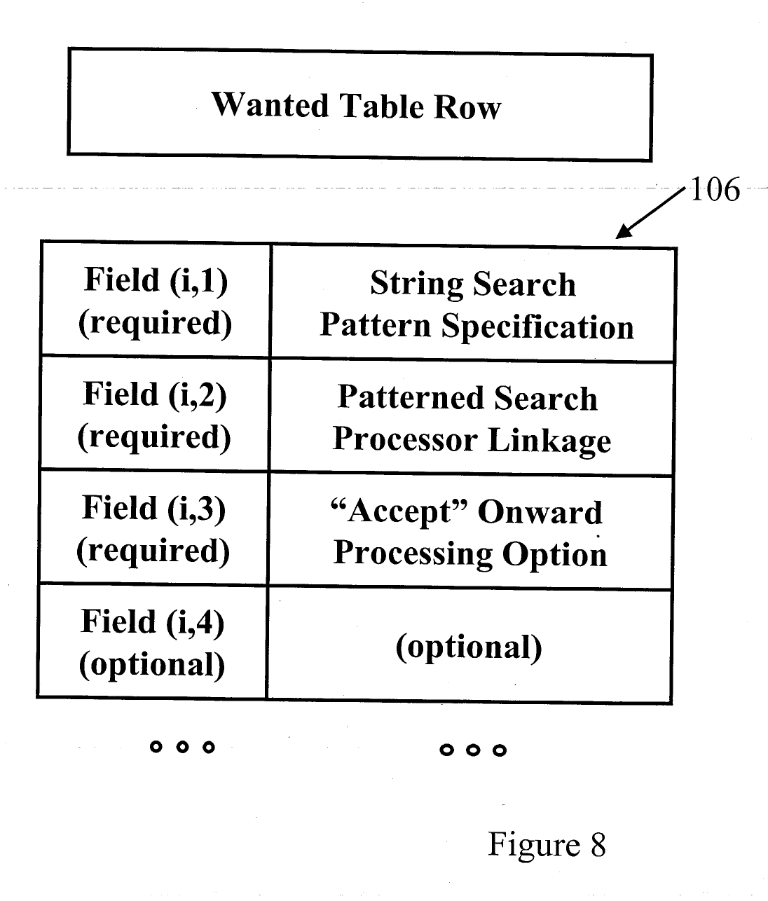

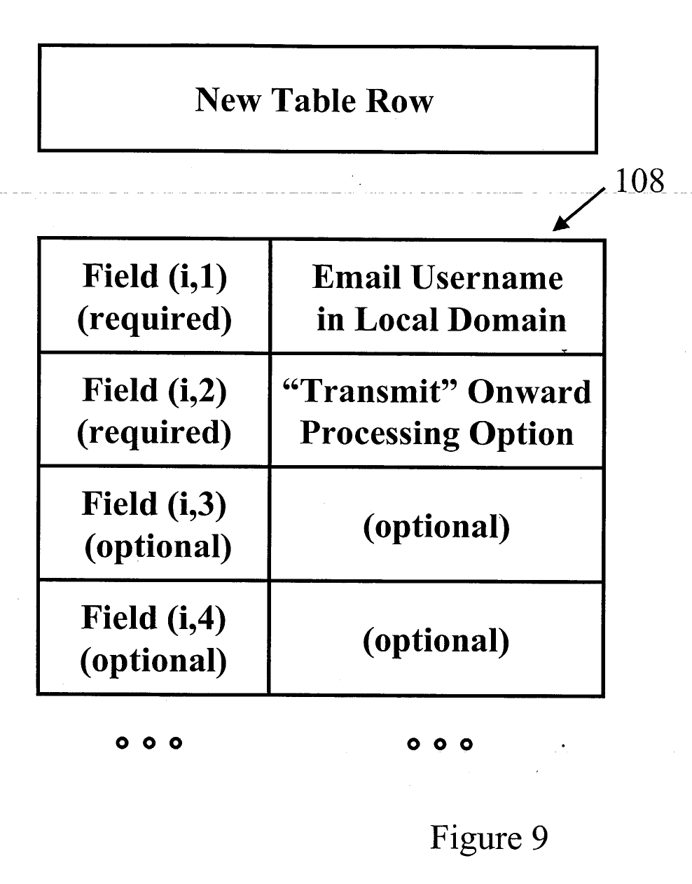

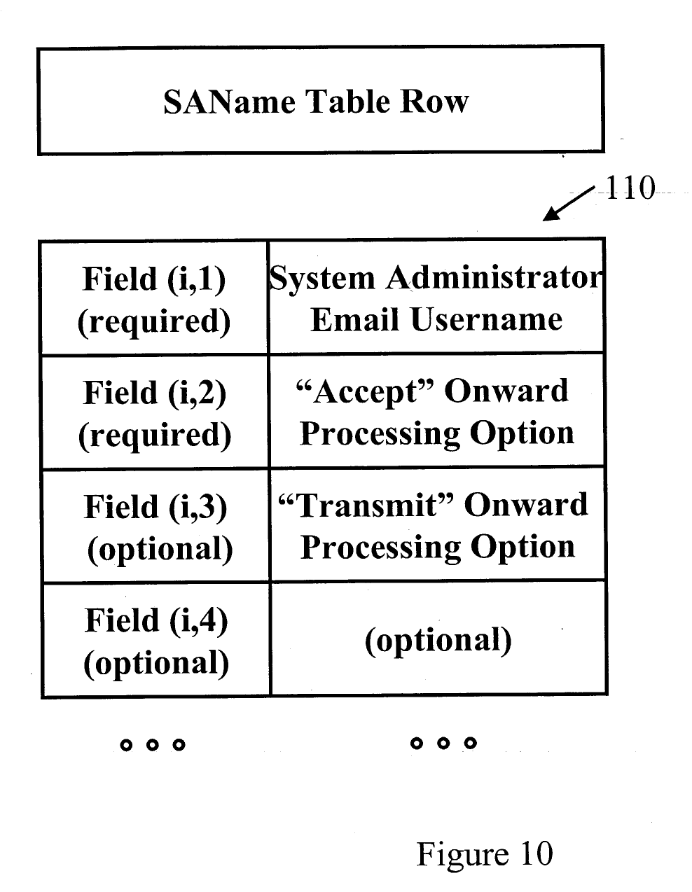

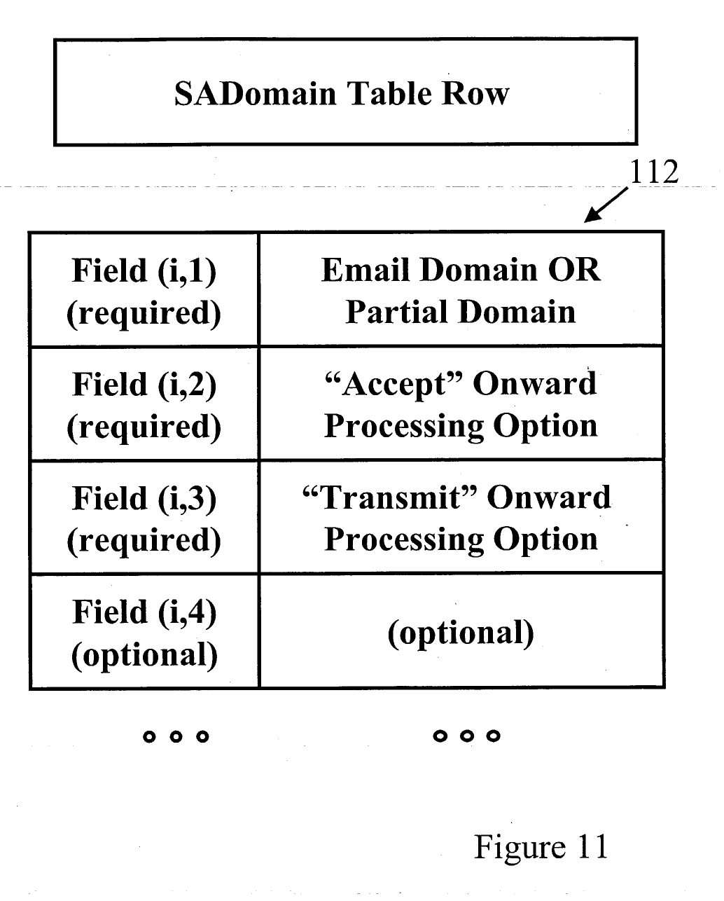

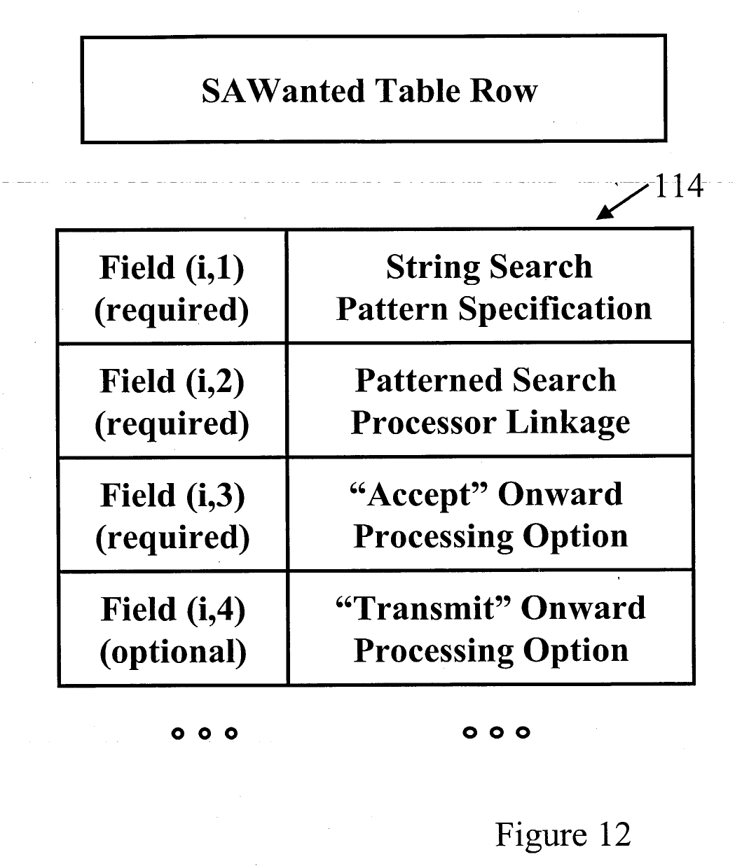

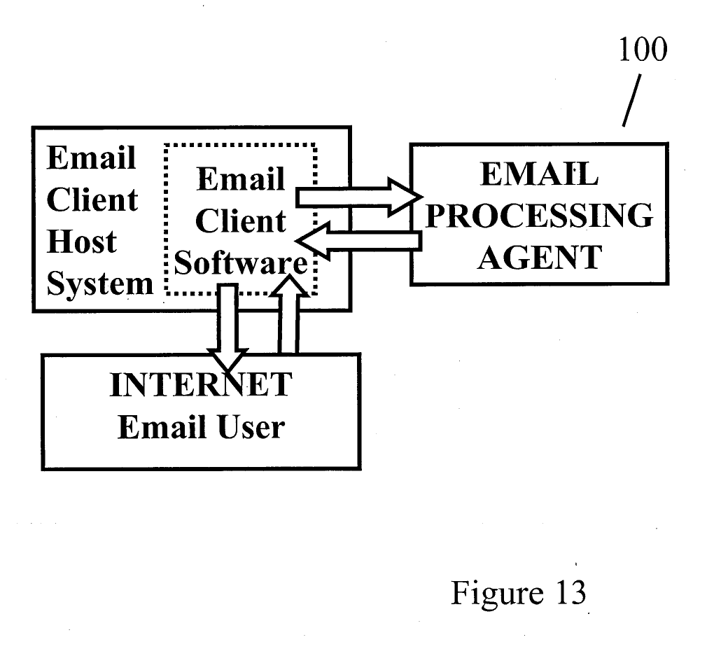

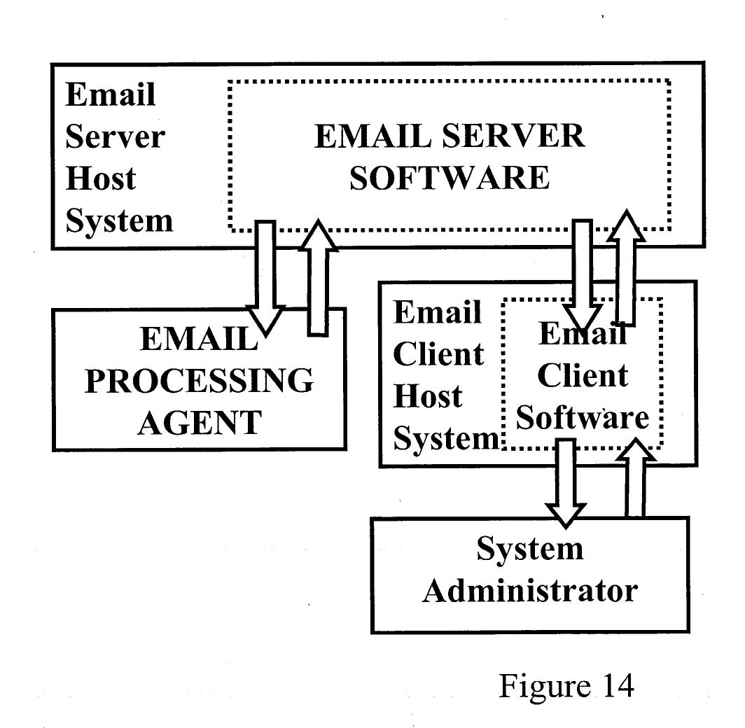

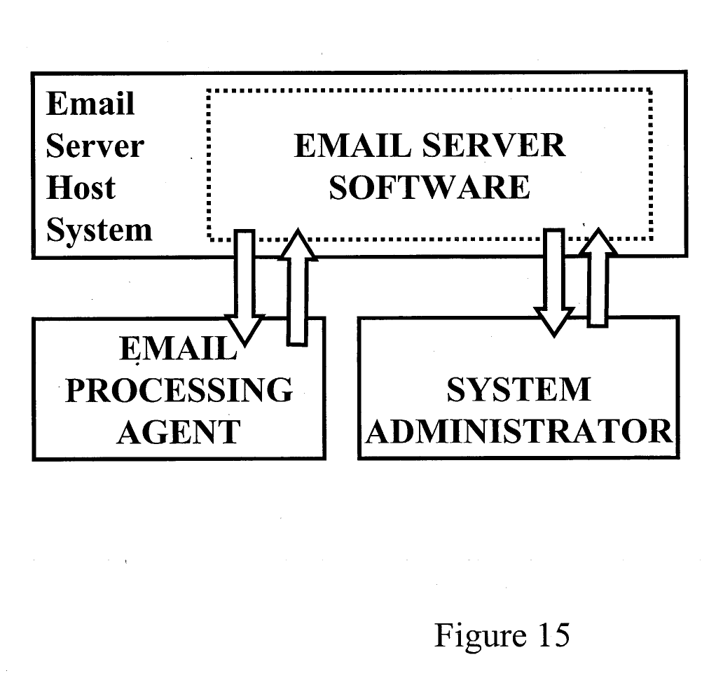

The matrix of data may conveniently be referred to as a control table. The e-mail processor 100 comprises at least one of the following control tables, which are described in more detail below: (1) an optional “private correspondents” table 102, a representative row of which is illustrated in FIG. 6, (2) an optional “public correspondents” table 104, a representative row of which is illustrated in FIG. 7, (3) an optional “wanted subject matter” table 106, a representative row of which is illustrated in FIG. 8, (4) an optional “new correspondents” table 108, a representative row of which is illustrated in FIG. 9, (5) an optional “system administrator e-mail usernames” table 110, a representative row of which is illustrated in FIG. 10, and (6) an optional “system administrator domains of interest” table 112, a representative row of which is illustrated in FIG. 11, and (7) an optional “system administrator wanted subject matter” table 114, a representative row of which is illustrated in FIG. 12.

The first one to four of these tables are used to define precisely which e-mails are to be accepted and which e-mails are to be transmitted by an e-mail server and/or an e-mail client operating on the e-mail user's behalf. The last one to three of these information structures are used by the system administrator of an organizational system mail server domain, or administrator of an Internet Client Account, to monitor, manage, and control all e-mail messages received by, and/or transmitted from or within, the domain.

Briefly, the Private Correspondents Table 102 (hereinafter, the “Private Table”) specifies one or more e-mail users and/or e-mail domains from which e-mail is always to be accepted and to which e-mail is always to be transmitted. Thus, as explained shortly, one can define all e-mail from “smith@hotmail.com” as acceptable, or can simply define e-mail from “hotmail.com” as acceptable. As illustrated in FIG. 6, a total of i e-mail users and/or e-mail domains can be accommodated by the i-row table 102. Field (i,1) contains the e-mail address of domain of a first accepted source of e-mail. Field (i,2) optionally contains a pre-defined action select code which is to be performed prior to or following acceptance of an e-mail meeting the Field (i,1) criteria. Field (i,3) optionally contains a pre-defined action select code which is to be performed prior to or following transmission of an e-mail meeting the Field (i,1) criteria. Field (i,4) as well as any additionally provided fields can be used by the system or software designers as they wish. Accordingly, the fields of each row pertain to a different e-mail user address or domain.

The Public Correspondents Table 104 (hereinafter, the “Public Table”) is illustrated in FIG. 7, and defines one or more local organizational domain e-mail usernames for whom e-mail is always to be accepted, and for whom e-mail is always to be transmitted, by the server. As illustrated, the preferred data structure of the Public Table 104 is similar to that of Private Table 102. The Public Table 104 is primarily intended to permit selected users within the organization and e-mail users in an Internet Client Account to receive unsolicited e-mails relating to the organization's functions and operations (e.g.; “sales”, “tech support”, etc.) and to allow those defined users to initiate e-mail correspondence with other e-mail users in pursuit and support of those functions and operations. While the Public Table's functions may be necessary and desirable to an organization, it does permit receipt by those users of abusive e-mail and junk e-mail with which the organization must be prepared to deal. Those organizations must now deal with such mail in any event, so the Public Table at least limits its receipt to a relatively few usernames that the organization can control and change from time to time.

The Wanted Subject Matter Table 106 (hereinafter, the “Wanted Table”) is illustrated in FIG. 8. As illustrated, the preferred data structure of the Wanted Table 106 is similar to that of Private Table 102. The Wanted Table 106 specifies one or more words or phrases (i.e., ordered sets of one or more “words”) which must appear in the e-mail's “Subject:” field if the e-mail is not from a Private Correspondent identified in the Private Table 102. Thus a user can define as acceptable, e-mail pertaining to topics, organizations and/or sources that are of specific interest to the user. For example, communications received through bulletin boards typically begin the “Subject” line with a phrase in brackets that identifies the bulletin board as the most immediate source of the communication, so these communications can be defined as acceptable regardless of the fact that the author is not listed in the Private Table 102.

The New Correspondents Table 108 (hereinafter, the “New Table”) is illustrated in FIG. 9. As illustrated, the preferred data structure of the New Table 108 is similar to that of Private Table 102. The New Table 108 identifies one or more e-mail usernames at the local domain for whom e-mail is always to be transmitted. Use of this functionality allows an e-mail user who is not included in the Public Table to send an e-mail to a correspondent not in the Private Table—thus eliminating exposure to uncontrolled and unwanted e-mail responses since this table is not referenced during e-mail acceptance testing and, hence, has no impact upon the acceptance of e-mails. This is an important tool in minimizing the amount of unwanted e-mail received by an e-mail user, since uncontrolled public access to an e-mail user increases the risk of receiving enormous amounts of junk mail and mail unrelated to the function of the organization.

E-mail users can employ the New Table functionality in conjunction with the Wanted Table to control the degree to which (and the conditions under which) the recipients of the user's e-mails can respond. For example e-mail from a user whose transmission is controlled by this table can require that recipients include specific text in the “Subject:” field of responding e-mails. Alternatively, response can be limited to telephone, fax, or any other desired mode of communication or responsive conduct. In effect, the New Table 108 provides the personal e-mail user with all of the transmit capabilities of the organizational Public Table without the accompanying penalties of unrestricted vulnerability to junk mail.

The System Administrator E-mail Username Table 110 (hereinafter, the “SAName Table”) is illustrated in FIG. 10. As illustrated, the preferred data structure of the SAName Table 110 is similar to that of Private Table 102. The SAName Table 110 specifies the e-mail address of each domain System Administrator. If this e-mail address is found in the “From:” field of an Internet or of an intranet e-mail, the e-mail will always be accepted or transmitted

The System Administrator Domains of Interest Table 112 (hereinafter, the “SADomain Table”) is illustrated in FIG. 1. As illustrated, the preferred data structure of the SADomain Table 112 is similar to that of Private Table 102. The SADomain Table 112 specifies strings that represent entire or partial DNS domain names. This table's content is applied to the “To:” field and to the “From:” field of all domain e-mail prior to application of any other acceptance or transmittal criteria defined by a Private Table, Public Table, Wanted Table and/or New Table. This functionality permits a System Administrator or a Internet Client Account Administrator in a sub-domain of email user screen names to monitor and control e-mail based on the email addresses included in the e-mail.

The System Administrator Wanted Subject Matter Table 114 (hereinafter, the “SA Wanted Table”) is illustrated in FIG. 12. As illustrated, the preferred data structure of the SA Wanted Table 112 is similar to that of Private Table 102. The SA Wanted Table 114 is essentially identical in function and application to the Wanted Table; however, the SA Wanted table's content is applied to the “Subject:” field and, optionally, to the Message field of all domain e-mail prior to the application of any other acceptance or transmittal criteria defined by a Private Table, Public Table, Wanted Table and/or New Table to permit a System Administrator or a Internet Client Account Administrator in a sub-domain of e-mail user screen name to monitor and control e-mail based on the text content of the e-mail.

In operation, e-mail processing agent 100 uses a number of conveniently pre-defined string operation functions to analyze and filter the incoming and outgoing e-mail. Those skilled in the art will recognize that the string functions may be an integral part of the employed programming language, or may utilize procedures of the programming language's execution support library if the language does not include such functions. Regardless of how provided, the basic string operation functions are:

LENGTH—to report the current dynamic length of a string;

CONCATENATE—to create single string by appending one string to another;

SUBSTRING—to extract a variable number of characters from an existing string starting at a specified character position in the existing string; and

COMPARE—to compare corresponding characters of two strings and determine their equality or inequality.

The ‘length’ of each text string is preferably defined to be the number of contiguous text characters contained in the string. If the string contains no characters, it will be referred to herein as an “empty string”.

In the preferred embodiment, the e-mail processing agent 100 finds two strings to be “equal” or to “match” only when the length of both strings is equal and the corresponding character codes of both strings are identical when compared with the case sensitivity selected. Thus, “Xerox” and “xerox” are equal to each other with a case insensitive compare, but they are not equal to each other with a case sensitive compare.

In operations involving the Private Table, the Public Table, the New Table, the SAName Table and the SADomain Table, the e-mail processor 100 need only compare two text strings containing an entire or a partial e-mail address. The form and content of these strings are defined by protocol and standards. In operations involving the Wanted Table, the e-mail processor preferably provides text discrimination capabilities, which permit an e-mail user to easily formulate the Wanted Table search pattern. Using the term “word” to mean one or more alphabetic and/or numeric characters preceded and followed by either a white space or a punctuation character, the preferred e-mail processor 100 permits the characters of a word to be conveniently replaced by the familiar search operator “?” to match any single character in a “subject field” word being examined, and by the familiar search operator “*” to match all characters to the end of the “subject field” word being examined). In addition, the user is preferably permitted to select whether the comparison operation is to be case-insensitive (e.g., both comparand strings are converted to lower case before the comparison) or case sensitive (in which both comparand strings are compared without modification to their existing form), and whether the order of the words' appearance in the subject field is to be (1) in the order specified (with only white space and punctuation character(s) intervening), (2) in the order specified with intervening words permitted in addition to spaces and punctuation or (3) in any order.

The syntax, semantics and idiom of the language used to formulate and specify text string search patterns are determined by the manufacturer of the string search procedure. To extend the processor's functionality to apply to a wide range of natural (human) languages, any desirable software text search mechanism can be employed to perform the required assessment.

As illustrated in FIG. 8, for example, Wanted Table Column 1 values are text strings which contain a search pattern specified in the language of the search mechanism to be applied to perform the assessment. Column 2 specifies the information necessary to transfer control to the appropriate string search procedure, which can be invoked to supply the required pattern discrimination functionality and a “match/no match” assessment result.

In practice, it should be recognized that the e-mail processor 100 may be an inherent part of the user's e-mail client software or e-mail server software, and the actual dialog with, and presentation to, the e-mail user would then most likely be a user-friendly extension of that software's conventions in order to maintain the familiarity and uniformity of the overall product interface. It is to be expected that the software for the e-mail processor 100 will be implemented by the manufacturer of the e-mail client software and the e-mail server software, and that the programming standards and methods of that organization will govern the design and implementation of processor 100 functions. Implementation might take the form of a Visual Basic Control, using the control's properties to transmit parametric values, or might be a set of C or C++ procedures whose invocation sequence includes the parametric values. Naturally other methods could be used as well. The reader will understand that these matters are independent of the nature of the invention. Consequently, the following discussion is focused on the preferred information content and preferred logic and function of the preferably utilized algorithms, and not on the actual implementation method, coding techniques or data formats employed.

As described earlier, FIG. 5 schematically illustrates the preferred informational structure of the Private Table, Public Table, Wanted Table, New Table, SAName Table, SAWanted Table and SADomain Table (hereinafter referred to generically as the “Control Tables”), recognizing that the term may apply to less than all of them, and that each table need not have an informational structure identical to any other table. Each Control Table is preferably composed of Control Table rows (illustratively shown in FIG. 5 as rows 1-3) Control Table columns (illustratively shown in FIG. 5 as columns 1-3) and Control Table Fields which can conveniently be assigned the generic nomenclature, format, organization and field content presented in FIG. 5.

The Private Table (FIG. 6), Public Table (FIG. 7), Wanted Table (FIG. 8), New Table (FIG. 9), SAName Table (FIG. 10), SADomain Table (FIG. 11) and SAWanted Table (FIG. 12) are optional tables and need not contain any rows of data (i.e., an “empty table”). Individual empty tables are recognized by the discriminatory functions of the e-mail processor 100 but empty tables have no impact on the continued operation of the processor's discriminatory functions.

The acceptance or transmission of each e-mail processed in the domain is initially determined by the content of the SAName Table, SADomain Table and SAWanted Table. If the SAName Table is empty, the SADomain Table and SAWanted Table will also be empty since the content of these latter two tables can only be defined by a System Administrator. If the SADomain Table and/or the SAWanted Table are not empty, their content will be applied to the applicable text field(s) of the e-mail. Subsequent processing of the e-mail becomes the System Administrator's choice if one of the SAWanted Table or SADomain Table entries is matched in the email. Otherwise, standard acceptance or transmission decision processing ensues.

If the e-mail does not meet the criteria of the foregoing SA tables, the e-mail acceptance decision is then determined by the contents of the user's Private Table, the Public Table and the Wanted Table. If these three tables are empty, no e-mail will be accepted. Similarly, the decision as to whether transmission of a particular e-mail is permitted is determined by the contents of the Private Table, the Public Table and the New Table. If these three tables are empty, no e-mail will be transmitted.

If the “To:” field of an e-mail and the “From:” field of the e-mail contain identical e-mail user addresses, the e-mail will always be accepted and/or transmitted-allowing e-mail users to create e-mail for transmission to themselves at another site.

If the “To:” field of an email contains multiple e-mail user addresses, the e-mail will be accepted only if (1) the “From:” field e-mail user address matches an entry in the Private Table or (2) the “Subject:” field content matches a search pattern in the Wanted Table or (3) one of the e-mail addresses in the “To:” field matches an entry in the Public Table. Similarly, if the “To:” field of an email contains multiple e-mail user addresses, the e-mail will be transmitted only if (1) the “From:” e-mail user address matches an entry in the Public Table or (2) the “From:” e-mail user address matches an entry in the New Table or (3) all of the e-mail user addresses in the e-mail “To:” field match entries in the Private Table.

The only requirement for correct discriminatory functioning of the processor 100 is that the content of Column 1 of each Control Table Row be appropriate and correctly formed. It is reasonable to leave to the software which interfaces with the e-mail user the responsibility of defining the content of these control tables to ensure that values with the expected information content be formatted as expected and inserted into the expected location of each table. The preferred processor 100 accordingly need not perform any validity checks on the values which it examines and/or processes.

While these data structures are referred to as “tables”, it is not necessary that the information actually be maintained and presented in the form of a table. The data structures used for an implementation may vary as required to meet design objectives and constraints of the professional software engineering staff of the software manufacturer so long as the relationships and content of required table columns are preserved.

In the personal environment illustrated in FIG. 3, the control tables are preferably created and maintained by the e-mail user using the e-mail software manufacturer's supplied interfaces and facilities. The control tables are preferably stored in the e-mail client's host system 30 for local maintenance operations and for retrieval and use by the processor 100 when the e-mail client 30 is interacting with the e-mail server 32 on behalf of the e-mail user 29.

In the organizational environment illustrated in FIG. 2, the control tables are preferably created and maintained by the system administrator or other designated person or user through use of the e-mail software manufacturer's supplied interface and facilities. The control tables are preferably stored in the e-mail server's host system 28 for retrieval and use by the e-mail processor 100 when the e-mail server is interacting with an e-mail client on behalf an e-mail user. For security or other requirements, a software manufacturer may choose to supply table maintenance interfaces and facilities which can be employed by a system administrator or other designated person at the mail server system control console or other direct, non-networked access to the mail server system.

The algorithms utilized by the e-mail processor 100 are predicated on examining text strings of a variable length which are encoded in the same character set as content in Column 1 of the control tables, and which have been extracted from the fields in an e-mail whose function is to specify (1) the e-mail addressee (the “To:”, “cc:” and “bcc:” fields), (2) the e-mail sender (the “From:” field), (3) the subject (the “Subject:” field) and (4) the message (the “Message:” field) regardless of how these fields are actually labeled or identified in the e-mail. In this way, the preferred processor 100 need not be sensitive to or understand the transmittal structure and information formatting (e.g., HTML, plain text, etc.) employed to represent the e-mail, and does not need access to the actual e-mail content that is stored and awaiting discriminatory post-processing. In fact, the processor itself does not need to know which piece of e-mail the specific field was actually extracted from.

Column 1 of the Private Table, Public Table and New Table, SAName Table and SADomain Table (FIGS. 6-11, respectively) each hold text strings that specify either a complete e-mail username or an entire or partial e-mail domain name. When attempting to match values from these control table columns to text strings extracted from e-mails, the lower-case values of both strings are compared.

Column 1 of the Wanted Table and of the SAWanted Table contains a text string that describes a pattern that specifies (in the syntax and semantics of the text search mechanism supplied by the software manufacturer) the content that must appear in the “Subject:” field and/or “Message:” field of an e-mail if the e-mail is to be accepted.

Column 2 of the Wanted Table and of the SAWanted Table contains the information necessary to transfer parametric values and execution control between the processor 100 and the cognizant text string search processor. Such transfers may be accomplished by direct procedure invocation, by interrupt or any other mechanism supported in the host system hardware and software systems. The invoked processor need only return a “match found/no match found” status indicator and execution control to processor 100 to continue the discriminatory processes.

If menus of post-processing action options by the processor 100 are supplied by the e-mail server and/or by the e-mail client software manufacturer, Column 2 and/or Column 3 and/or Column 4 provide locations to store the e-mail user's option selection for use in the event of successful match on Column 1 of the row. Since the applicable Table Identifier and “matched” Table Row Number are output from a successful test, highly individualized action sequences may be customized to deal with incoming and outgoing e-mail. The action option(s) selected can be immediately determined by simple table lookup.

To evaluate the content of the e-mail “Subject:” field, a complete pattern specification must necessarily include one or more words, whether the pattern content is to be used as a case-sensitive or a case-insensitive value, and the appearance combinations and orders that are permitted for multi-word content.

Hence, regardless of which control table is involved, the successful application of the decision criteria value contained Column 1 of a row will preferably cause the e-mail processor 100 to output an “accept” or “transmit” status indication, the ID of the control table which was the source for the decision and the number of the control table row which was the source for the decision.

Where an e-mail contains identical “To:” and “From:” field e-mail user addresses (i.e., a self-addressed e-mail), a convention is conveniently established that the e-mail processor 100 indicates Row 0 of the Private Table as the justification for acceptance or transmission of the e-mail. Use of this convention removes the necessity of defining an entry for each domain e-mail user name in the Private Table.

Column 2 and the following columns in each control table provide a mechanism through which onward acceptance or transmission post-processing of an e-mail may be individually specified based on the Column 1 content of the row.

In the absence of a match between the appropriate e-mail field(s) and the Column 1 value(s) of the utilized control tables, the preferred e-mail processor 100 denies permission for acceptance of the e-mail. Similarly, the preferred processor 100 denies permission for sending an e-mail when there is no match between the content of the appropriate e-mail field(s) and any of the Column 1 value(s)s in the corresponding control table(s) utilized. Since the denial of permission may not be associated with a single control table, the manufacturer of the e-mail server software and/or the e-mail client software is preferably responsible for providing automated onward processing options to the e-mail user in these situations. Such options might include filing, forwarding, returning, deleting, reporting, bouncing and/or other actions selectable and configurable by the e-mail user to meet that user's needs.

An assortment of automated Column 2 and/or Column 3 and/or Column 4 post-processing actions to be performed prior to or following e-mail acceptance, or prior to or following e-mail transmission, can be assumed to be desirable simply based on normal manual e-mail processing procedures. Concomitantly, each such action normally requires more information than just the action operation desired. Such actions could include, for example, “file a copy <in folder3>”, “forward to a copy to <wife@xyz.com>”, “distribute copies using <list5t>”, and “initiate execution of <mail_processing_program15>”. The specific actions which are supported, information required, and other aspects of the creation and maintenance of these facilities will be decided by the manufacturer of the e-mail server and e-mail client software.

In a text string search, it may be necessary to parse the pattern string and/or the string being searched into smaller, meaningful, language-specific strings (termed “words”) that are separated from adjacent words by (one or more) language-specific “whitespace” characters (i.e.; the space character between two words in the English language dialects). Also, the English language embodies the concept of “upper-case/lower-case”—capitalization of some language text characters when desired for semantic or idiomatic reasons. In order to convert a text string from upper-case to lower-case when required, it is necessary to understand the mapping of upper-case characters to lowercase characters (i.e.; “A” to “a”).

Other natural (human) languages use different character sets to express words, whitespace and case. To correctly interpret the contents of text patterns and fields, it is necessary to define both the functional usage of each code set character which may appear in an e-mail text field and, as applicable, the mapping of upper-case to lower-case characters when such is defined for the natural language used in the e-mail.

To extend the functionality of the e-mail processor 100 to as many languages as possible while facilitating and minimizing necessary software modifications, the e-mail processor 100 provides an invoker with the option to supply the requisite human-language-specific information in the form of tables which may be utilized by the processor 100 to parse text strings and/or convert the case of text strings of each e-mail whose text fields are examined. Applying this information, other natural languages which employ a left-to-right, top-to-bottom reading scan and whose character set can be represented in the e-mail processor (hardware and software) system of residence can be accurately processed by the same text pattern search mechanism. For those natural languages which can be represented in the e-mail processor system of residence but which employ other-sequenced reading scans, appropriate text search processors can be incorporated to perform the requisite search.

Every computer-based code set defines the number of sequential “bits” (“0” or “1” values) which are grouped to constitute a “character” and assigns a representation to each. In addition to its language-dependent usage and meaning, each character's sequential bits form a numeric value representing its unique numbered position in the code set (starting with “0” and ranging to 1 less than the total number of characters in the code set). The American Standard Code for Information Interchange (“ASCII”) is just one or many code sets in use today. This code set will be used for examples in the following discussion since the general algorithms are applicable to all codes of this type.

Many code sets which are employed in e-mails represent natural languages other than a dialect of the English language. Since the e-mail processor 100 is called upon to analyze and compare strings and string subsets, it is preferred that the processor's text-search algorithms to be aware of the functional classification of each character which may appear in a text string that it may need to examine so that it can properly parse and operate on the string for discriminatory purposes.

As a partial, non-exhaustive example using the ASCII code set, a character can be functionally classified in the context of and for use in a specific application domain as:

Upper case alphabetic—i.e., ‘M’

Lower case alphabetic—i.e., ‘k’

Numeric—i.e., ‘6’

Punctuation—i.e.,“;”

Whitespace—i.e.,‘ ’

Control—i.e. <tab>

Special Purpose—i.e.,

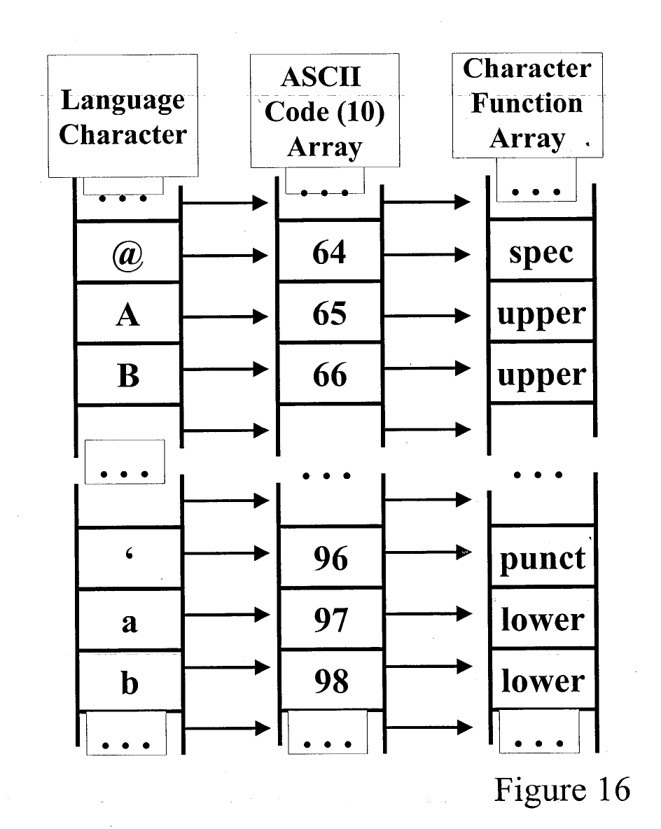

One technique for performing such a functional classification is presented in FIG. 16. In this method, an array (with index range of ‘0’ to ‘n’—where ‘n’ is the total number of characters in the code set) is created which contains an element for each character in the code set. The description of a specific character's function occupies the array element whose retrieval index is the numeric value of the character's code set bits. Each such element will contain the classification description of the character in the representation selected for implementation—e.g.; ‘U’ or ‘1’ or ‘upper’ for upper case alphabetics, ‘L’ or ‘2’ or ‘lower’ for lower case alphabetics, etc. Classification of each character then consists of a simple table lookup operation. Substitution of the appropriate tables then permits the same algorithm to be used to address other natural languages. An equivalent function can be implemented using other techniques and the actual method will be a design decision by the e-mail server and e-mail client software manufacturer.

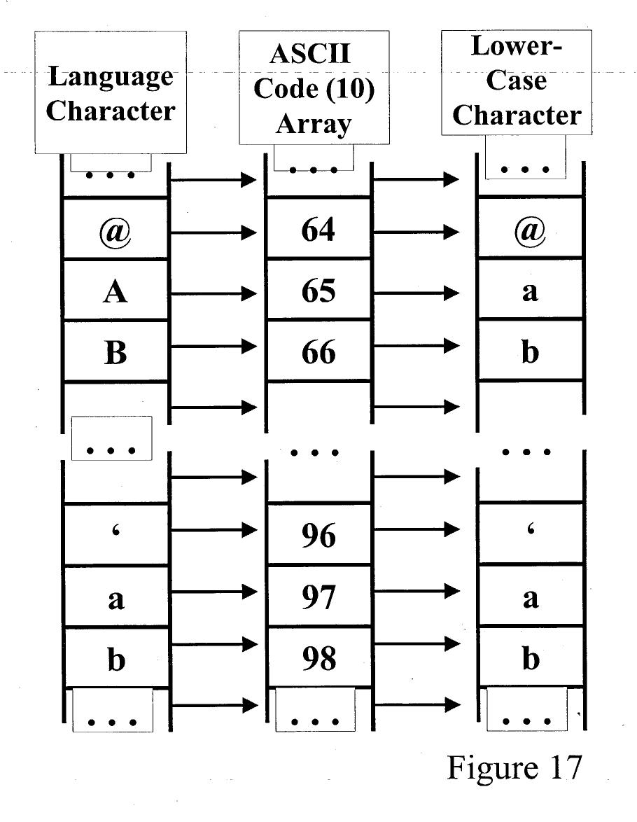

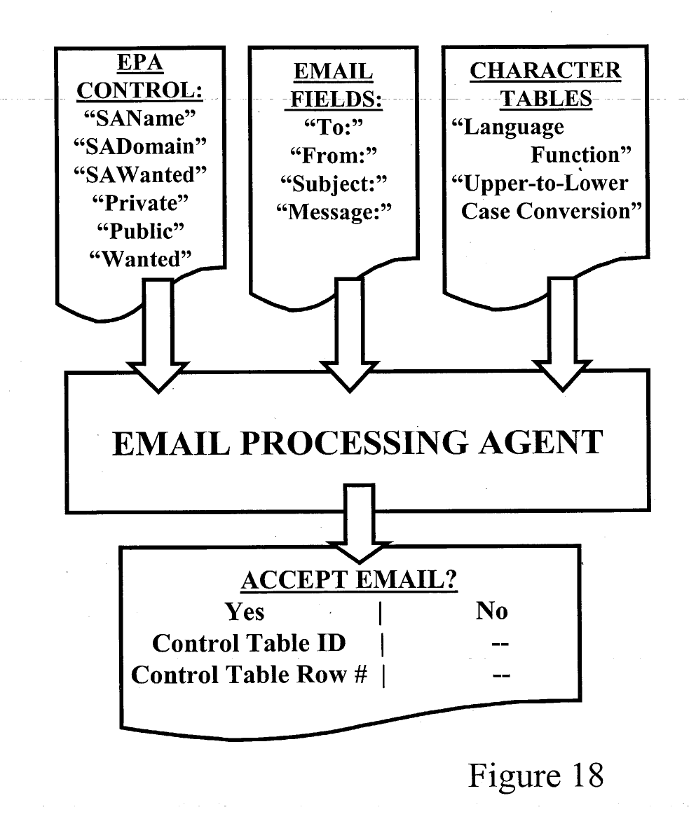

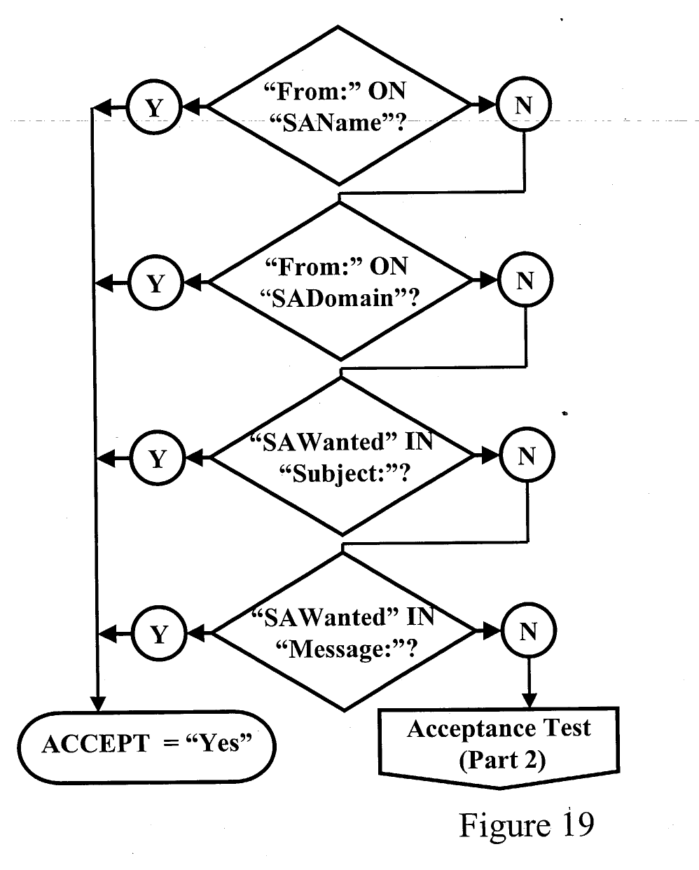

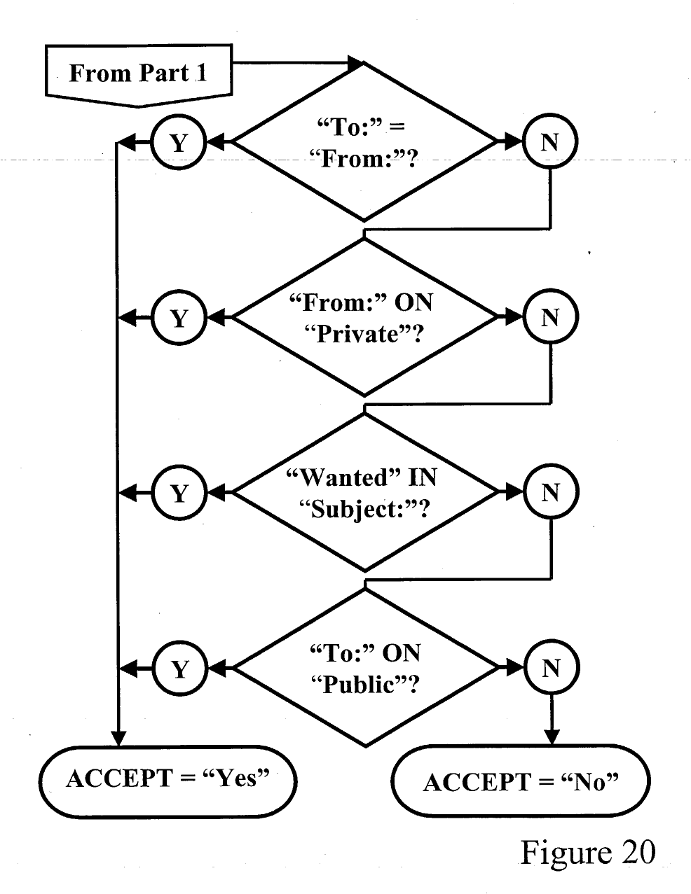

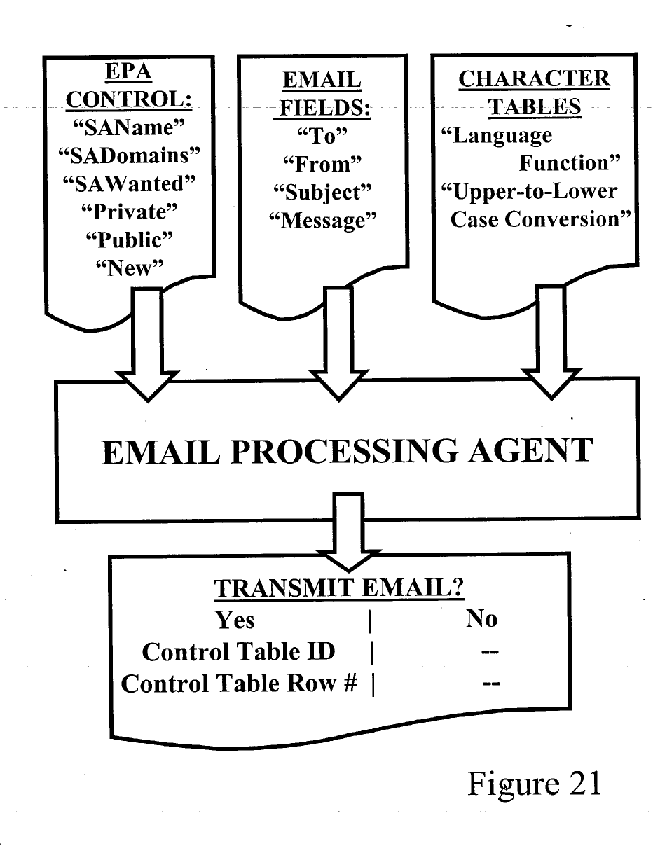

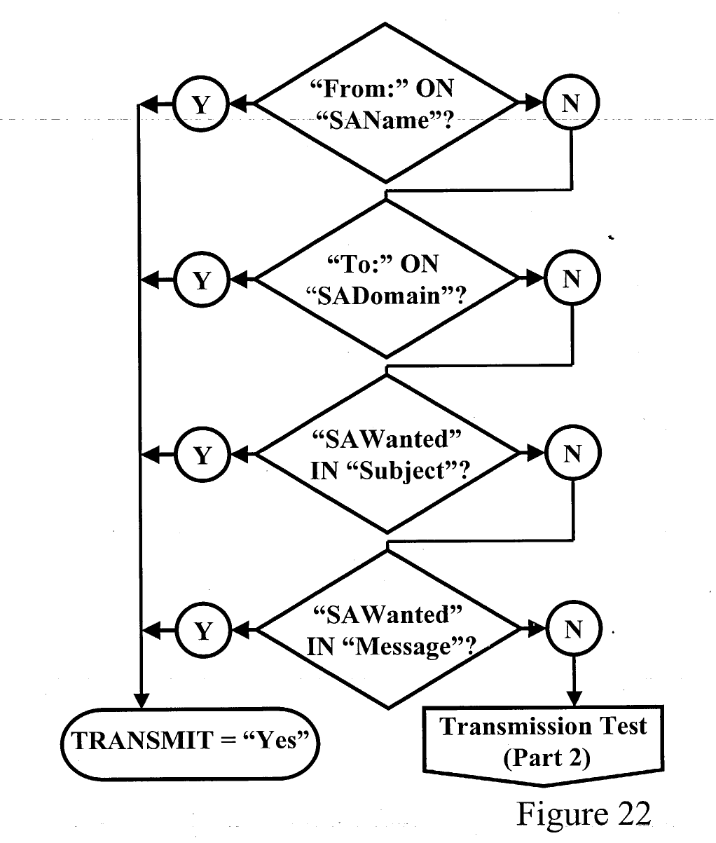

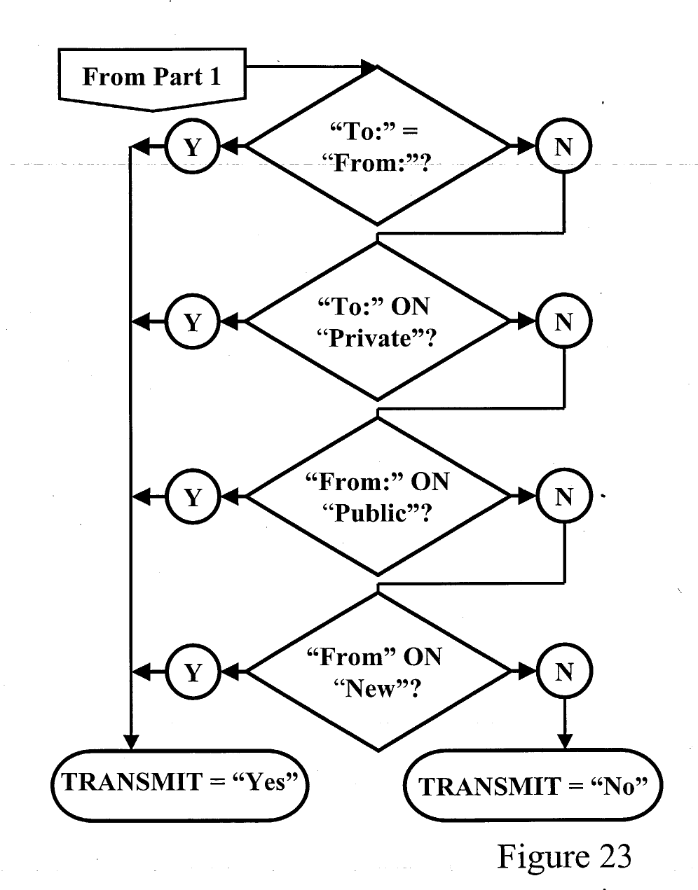

One technique for converting upper case characters to lower case characters (depicted in FIG. 17) is a variant of the technique previously described for determining a character's language function. In this case, an array is created which is in one-to-one correspondence with the code set characters and each element contains the character set code for the lower case version of the corresponding upper case character. An equivalent function can be implemented using other techniques and the actual method will be a design decision by the e-mail server and e-mail client software manufacturer.

Those skilled in the art will recognize that the invention herein is not limited to communication systems using the Internet, but can be utilized with equal success within any communication system where it is desired to control the acceptance and/or transmission of electronic messages. Additionally, those skilled in the art will recognize that the messages are not only those intended for, or prepared by, human users, but also for and by electronic and/or neural devices which exist now and in the future.

Accordingly, while the foregoing description includes details which will enable those skilled in the art to practice the invention, it should be recognized that the description is illustrative in nature and that many modifications and variations will be apparent to those skilled in the art having the benefit of these teachings. It is accordingly intended that the invention herein be defined solely by the claims appended hereto and that the claims be interpreted as broadly as permitted in light of the prior art.

I claim:

1. For use in an e-mail communication system of the type in which e-mail is sent from a sender to an addressee, an e-mail processor for virtually eliminating unwanted e-mail comprising:
means for storing one or more data groups, each group consisting of from none to a plurality of data strings defining an e-mail user's acceptance criteria and transmission criteria for e-mail processed by the system;
means for comparing data strings extracted from at least one of the “From:”, “To:”, “Subject:” and “Message:” fields of an e-mail with stored group data strings in the storage means to determine if the e-mail meets the criteria defined by the stored group data strings; and
means for accepting incoming e-mail for communication to the addressee of the e-mail if any of the acceptance criteria defined by the group data strings are met, and for blocking the incoming e-mail from being communicated to the addressee if none of the acceptance criteria are met.

2. The processor of claim 1 including means for permitting at least some of the stored data strings to be stored by the addressee.

3. The processor of claim 1 including means for permitting at least some of the stored data strings to be stored by the system administrator of an organizational mail server.

4. The processor of claim 1 including means for permitting at least some of the stored data strings to be stored by the addressee's System Administrator.

5. The e-mail processor of claim 1 further including:
means for accepting outgoing e-mail from the sender for transmission to the addressee if any of the transmission criteria defined by the group data strings are met, and for blocking the outgoing e-mail from being communicated from the sender if none of the transmission criteria are met.

6. The processor of claim 5 including means for permitting at least some of the stored data strings to be stored by the sender's system administrator.

7. The processor of claim 1 including means for permitting at least some of the stored data strings to be stored by the sender's system administrator.

8. The processor of claim 1 wherein the processor is resident at the physical location of the addressee.

9. The processor of claim 1 wherein the processor is resident at a location selected by the addressee's system administrator.

10. The processor of claim 1 wherein the processor is resident at a location selected by the addressee's ISP.

11. The processor of claim 1 wherein the processor is resident at a location selected by the sender's system administrator.

12. The processor of claim 1 wherein the processor is resident at a location selected by the sender's ISP.

13. For use in an e-mail communication system, an e-mail processor for substantially eliminating the communication to an intended recipient of unwanted e-mail comprising:
means for storing data strings indicative of e-mail authorized for communication to the intended recipient;
means for reading selected data strings of e-mail;
means for comparing the stored and read data strings to identify a match; and
means for rejecting the e-mail if no match is found.

14. The e-mail processor of claim 13 including means for storing data strings identifying an acceptable e-mail source, said source being selected from the group consisting remote e-mail users, domain names and a combination of e-mail users and domain names from which e-mail is always to be accepted.

15. The e-mail processor of claim 13 including means for storing data strings identifying e-mail content which is to always be accepted.

16. The e-mail processor of claim 13 wherein the rejection means includes means for rejecting the e-mail unless a match is identified between stored and read data strings pertaining to the e-mail's content and a match between stored and read data strings is additionally identified from the group consisting of (1) acceptable e-mail senders, (2) acceptable mail-generating domain names, and (3) acceptable e-mail recipients for which e-mail is always to be accepted.

17. The e-mail processor of claim 13 including means for storing data strings identifying e-mail content which is to always be accepted.

18. The e-mail processor of claim 13 including means for storing data strings identifying e-mail acceptable for transmission by the system.

19. The e-mail processor of claim 13 including means for storing data strings identifying one or more intended recipients for whom e-mail from any source is to be accepted.

20. The e-mail processor of claim 13 including means for storing data strings identifying one or more users of the system for whom all e-mail is to be transmitted by the system.

21. The e-mail processor of claim 13 including means permitting the intended recipient to create stored data strings defining which e-mail is authorized for communication to the intended recipient.

22. The e-mail processor of claim 13 wherein the data-string storing means includes means operable by the intended recipient for storing the data strings.

23. The e-mail processor of claim 13 wherein the data-string storing means includes means operable by the intended recipient for editing the data strings.

24. The e-mail processor of claim 23 including means for permitting an e-mail administrator to create stored data strings defining which e-mail is authorized for communication.

25. The e-mail processor of claim 24 wherein at least some of the data strings created by the e-mail administrator have a hierarchical relationship with the intended recipient's data strings, wherein the relationship is selected from the group consisting of definitions that can override those of the intended recipient's, definitions which are subservient to the intended recipient's and definitions which are supplemental to the intended recipient's.

26. The e-mail processor of claim 13 including means for permitting an e-mail administrator to create stored data strings defining which e-mail is authorized for communication.

27. The e-mail processor of claim 26 including means for permitting an e-mail administrator to edit stored data strings defining which e-mail is authorized for communication.

28. The e-mail processor of claim 27 including means for storing data strings identifying one or more e-mail sources within the system for whom e-mail is generally always to be transmitted.
